(19) United States
(12) Patent Application Publication
(10) Pub. No.: US 2026/0093848 A1
(43) Pub. Date: Apr. 2, 2026

(54) STORAGE MEDIUM FOR INSTALLING DRIVER, CONTROL METHOD FOR INSTALLING DTIVER, AND INFORMATION PROCESSING APPARATUS

(71) Applicant: CANON KABUSHIKI KAISHA, Tokyo (JP)

(72) Inventor: SHOICHI MATSUDA, Saitama (JP)

(21) Appl. No.: 19/347,155

(22) Filed: Oct. 1, 2025

(30) Foreign Application Priority Data
Oct. 1, 2024 (JP) 2024-172552

(51) Int. Cl. G06F 21/64; G06F 8/61

(52) U.S. Cl. CPC G06F 21/64; G06F 8/61

(57) ABSTRACT

A non-transitory computer-readable storage medium storing a program that installs a driver used to control a peripheral device of an information processing apparatus, the stored program, when executed by one or more processors of the information processing apparatus, executes a control method includes determining whether a base driver, which corresponds to an older version of the same type of driver as the driver, is installed on the information processing apparatus, installing a certificate corresponding to a digital signature included in a driver package of the base driver on the information processing apparatus based on a determination that the base driver is installed, and installing a driver file included in the driver package of the driver.

### BACKGROUND

### Field of the Technology

The present disclosure relates to a storage medium for installing a driver, a control method for installing the driver, and an information processing apparatus.

### Description of the Related Art

Typical print control programs for controlling printers are printer drivers for Windows®. A driver package for printer drivers for Windows® includes a CAT file (a catalog file). A digital signature can be added to the catalog file to prevent tampering with the driver (refer to, for example, Japanese Patent Laid-Open No. 2014-48956).

The digital signature is an encrypted form of the hash value of a file to which the signature is added by using a private key, and is used to prove that the file has not been tampered with. A certificate is added to the digital signature, and the hash value can be extracted by decrypting the hash value with a public key in the certificate. By comparing the extracted hash value with the hash value of the actual catalog file, the integrity of the catalog file is verified, enabling verification that the content of each file in the driver package has not been changed.

On the other hand, when a printer driver is installed on an information processing apparatus, such as a personal computer (PC), a check screen may be displayed with which a user checks whether to install the printer driver depending on the issuer of the digital signature added to the catalog file.

In the technique described in Japanese Patent Laid-Open No. 2014-48956, a check screen may be displayed at the time of a driver installation. Even if the user permits the installation on the check screen at the time of an initial driver installation, the installation check screen may be displayed again during the installation of an upgraded version of the driver. This occurs, for example, when the digital signature is changed before or after the version-upgrade.

It is redundant that the check screen is displayed again even though the user has installed the previous version of the driver and clearly intends to install a new version of the driver.

### SUMMARY

An aspect of the present disclosure is directed to improving convenience in the installation of an upgraded version of a driver.

According to an aspect of the present disclosure, a non-transitory computer-readable storage medium storing a program that installs a driver used to control a peripheral device of an information processing apparatus, the stored program, when executed by one or more processors of the information processing apparatus, executes a control method includes determining whether a base driver, which corresponds to an older version of the same type of driver as the driver, is installed on the information processing apparatus, installing a certificate corresponding to a digital signature included in a driver package of the base driver on the information processing apparatus based on a determination that the base driver is installed, and installing a driver file included in the driver package of the driver.

Features of the present disclosure will become apparent from the following description of embodiments with reference to the attached drawings. The following description of embodiments is described by way of example.

### BRIEF DESCRIPTION OF THE DRAWINGS

FIG. 1 illustrates a system configuration.

FIG. 2 illustrates a hardware configuration of a computer.

FIG. 3 illustrates a software configuration of the computer.

FIGS. 4A and 4B illustrate file configurations of installation sets of drivers according to a first embodiment.

FIG. 5 illustrates transition of screens displayed by an installer.

FIG. 6 illustrates a security warning screen displayed by an operating system (OS).

FIG. 7 illustrates a procedure of processing performed by the installer according to the first embodiment.

FIG. 8 illustrates a procedure of processing performed by an installer according to a second embodiment.

FIGS. 9A and 9B illustrate examples of uniquely stored information about drivers according to the second embodiment.

FIGS. 10A and 10B illustrate file configurations of installation sets of drivers according to a third embodiment.

FIG. 11 illustrates a security warning screen displayed by the OS when a scanner driver is installed according to the third embodiment.

FIGS. 12A and 12B illustrate examples of uniquely stored information about scanner drivers according to the third embodiment.

FIG. 13 illustrates transition of screens displayed by the installer when an upgrade installation is performed.

### DESCRIPTION OF THE EMBODIMENTS

### First Embodiment

Some embodiments of the present disclosure will now be described with reference to the drawings.

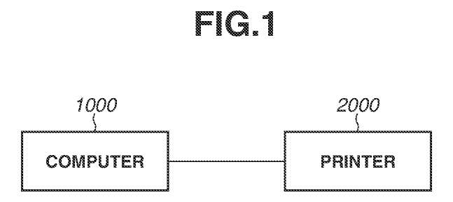

FIG. 1 illustrates a connection configuration of a computer 1000 and a printer 2000 in a print system according to the present embodiment. The computer 1000 and the printer 2000 are connected to each other via a network, a universal serial bus (USB), or the like, allowing communication with each other.

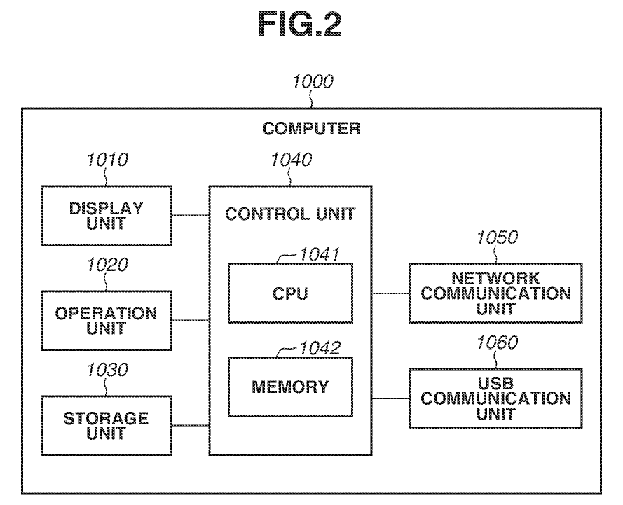

FIG. 2 is a block diagram illustrating a hardware configuration of the computer 1000.

The entire computer 1000 is controlled by a control unit 1040 including a central processing unit (CPU) 1041 and a memory 1042.

A display unit 1010 is an output device, such as a display, and an operation unit 1020 is an input device, such as a mouse, a keyboard, or a touch panel. A storage unit 1030 is a storage medium, such as a hard disk or a solid-state drive (SSD), that stores various kinds of software necessary for the computer 1000 to operate. An operating system (OS) 1110 and drivers, which will be described below, are also stored in the storage unit 1030.

A network communication unit 1050 connects to a network to perform data input and output with an external device. A USB communication unit 1060 performs data input and output with an external device via a USB connection. The computer 1000 and the printer 2000 are connected to each other via the network communication unit 1050 or the USB communication unit 1060.

All pieces of software processing according to the present embodiment are performed by loading software stored in the storage unit 1030 into the memory 1042 in the control unit 1040 and causing the CPU 1041 to execute the software. The network according to the present embodiment is used for performing data input and output with an external device. There is no need to communicate with an external server or the like.

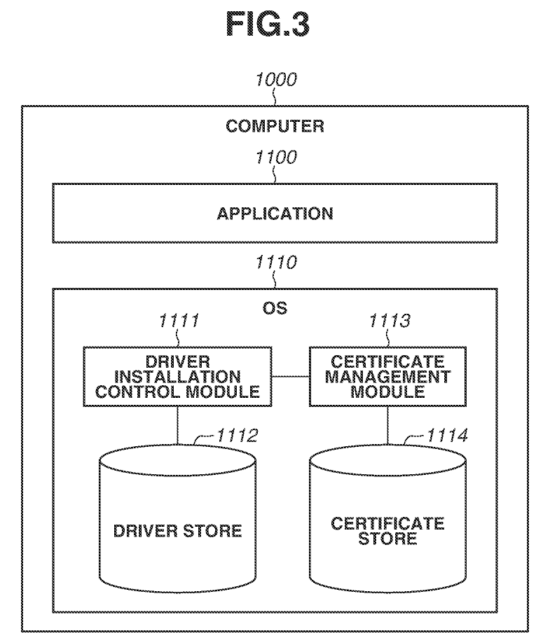

FIG. 3 is a block diagram illustrating a software configuration of the computer 1000 relating to a driver installation process according to the present embodiment. All pieces of the software are stored in the storage unit 1030. An application 1100 refers to desired software, such as word-processing software or spreadsheet software. An installer 1210 for installing drivers, which will be described below, is also an example of the application 1100.

The OS 1110 is software that controls the basic operation of the computer 1000. The OS 1110 includes a driver installation control module 1111 and a certificate management module 1113, and further includes data areas referred to as a driver store 1112 and a certificate store 1114, respectively.

The driver installation control module 1111 performs a control operation for installing a driver, which has been provided outside the OS 1110, on the OS 1110. The driver is software for controlling the peripheral apparatus 2000 from the computer 1000 and the driver is commonly provided from a vendor (a maker, or a manufacturer) of the peripheral apparatus 2000. The term “to install a driver on the OS 1110” means that a driver provided by a vendor is added to the OS 1110 to enable the peripheral apparatus to be operable from the computer 1000 under the control of the OS 1110.

The driver installation control module 1111 verifies drivers to be installed and stores the drivers in the driver store 1112. Thus, drivers for a wide variety of peripheral apparatuses are stored in the driver store 1112.

The certificate management module 1113 manages certificates registered in the OS 1110. The certificate store 1114 is managed by the certificate management module 1113, and stores various kinds of certificates used by the OS 1110. A certificate is used to verify the integrity of its corresponding digital signature, and the hash value can be extracted from the digital signature by using a public key included in the certificate. As a result, the certificate allows verification that the file to which the signature is added has not been tampered with.

Examples of information about a certificate include an issuer, version information, a serial number, a public key, and an expiration date. A certificate that has reached its expiration date needs to be reissued as a certificate with a new expiration date by updating the public key and the like. The certificates of the issuers trusted by the administrator or the user of the computer 1000 are stored in the certificate store 1114. According to the present embodiment, certificates having different expiration dates have different serial numbers, different public keys, etc., and are stored as different certificates in the certificate store 1114.

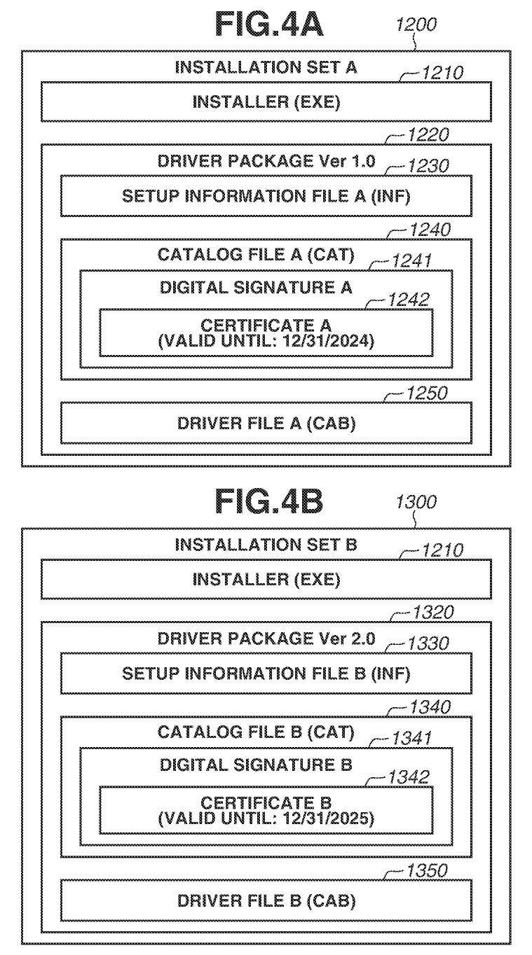

FIGS. 4A and 4B illustrate configurations of installation sets of drivers according to the present embodiment. FIG. 4A illustrates a file configuration of an installation set A 1200 of the initial version of a driver, and FIG. 4B illustrates a file configuration of an installation set B 1300 of the upgraded version of that driver.

The installation set A 1200 is a file set provided by a vendor, and includes the files described in the following. The installer (EXE) 1210 is the application 1100 for installing the driver. The installer (EXE) 1210 installs a driver file A 1250 on the OS 1110 by a user with the administrative right executing the installer (EXE) 1210.

The driver package A 1220 refers to a pre-installation driver-related file set, and includes a setup information file A (INF) 1230, a catalog file A (CAT) 1240, and the driver file A (CAB) 1250.

The setup information file A (INF) 1230 includes necessary information for installing the driver file A 1250. Specifically, the INF file 1230 includes the type and the version of the driver, the filename of the catalog file A 1240, the filename and the installation destination of the driver file A 1250, etc.

The catalog file A (CAT) 1240 is used when the driver file A 1250 is installed, to verify the driver package A 1220. The catalog file A (CAT) 1240 includes a digital signature A 1241 and a certification A 1242 of the driver file A 1250, and is used to check whether the signed driver file A 1250 has not been tampered with.

The driver file A (CAB) 1250 is the main body of the driver to be installed, and is a compressed file including an executable program and a data file for controlling the peripheral apparatus. It is on the assumption that the driver package A 1220 is at version 1.0, and the certificate A 1242, which is valid until December 31, 2024, is added to the digital signature A 1241 as its certificate.

The installation set B 1300 has the same file configuration as the installation set A 1200, except that a driver package B 1320 is stored as an upgraded version of the driver. According to the present embodiment, an installer (EXE) 1210 included in the installation set B 1300 is the same as that in the installation set A 1200. However, the installer (EXE) 1210 may be a different installer having an additional function, for example.

The driver package B 1320 includes a setup information file B (INF) 1330, a catalog file B (CAT) 1340, and a driver file B (CAB) 1350. The catalog file B (CAT) 1340 includes a digital signature B 1341 of the driver file B 1350. A certificate B 1342, which is valid until December 31, 2025, is added to the digital signature B 1341 as its certificate. The certificate B 1342 and the certificate A 1242 are different certificates.

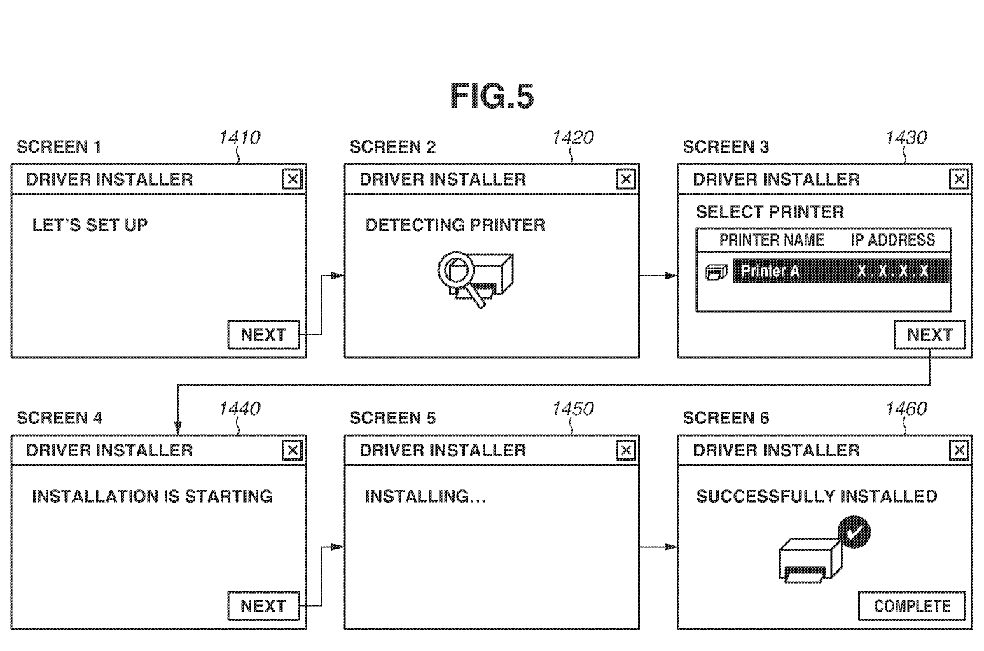

FIG. 5 illustrates transition of screens displayed on the display unit of the computer 1000 by the installer 1210 when the user executes the installer 1210 of the installation set A 1200. Transition of screens will now be described in a case where the user executes the installer 1210 without the certificate A 1242 installed in the certificate store 1114.

A screen 1 (1410) is displayed by the installer 1210 at the time of activation. In response to a “NEXT” button being pressed, the installer 1210 displays a screen 2 (1420). While displaying the screen 2 (1420), the installer 1210 detects whether a printer corresponding to the driver to be installed is currently connected to the computer 1000. When the detection is completed, the installer 1210 displays a screen 3 (1430).

A list of printers detected on the screen 2 (1420) is displayed on the screen 3 (1430), and the user is prompted to select which printer driver is to be installed. This driver corresponds to “Printer A” as the printer 2000. When the user selects the printer to be installed and presses the “NEXT” button, the installer 1210 displays a screen 4 (1440).

The screen 4 (1440) notifies the user of starting the installation of the driver. In response to the “NEXT” button being pressed, the installer 1210 displays a screen 5 (1450) and the installation of the driver starts. The installation of the driver is executed when the installer 1210 calls a driver-installation application programming interface (API) provided by the driver installation control module 1111 of the OS 1110. In this operation, the installer 1210 specifies the setup information file A 1230 in the driver package A 1220.

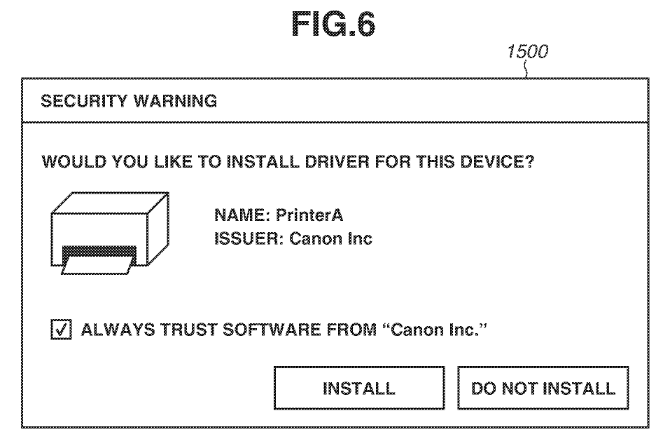

If the certificate A 1242 included in the installation target driver package A 1220 is not installed in the certificate store 1114, the OS 1110 displays a security warning screen. Details of the security warning screen will be described below with reference to FIG. 6. When the driver is successfully installed, the installer 1210 displays a screen 6 (1460) to notify the user of the completion of the installation, and the process ends.

FIG. 6 illustrates a security warning screen 1500 displayed by the OS 1110 while the above-described screen 5 (1450) is being displayed by the installer 1210 during the driver installation.

By the driver installation API being called, the OS 1110 acquires the filename of the catalog file A 1240 included in the specified setup information file A 1230. The OS 1110 refers to the catalog file A 1240 corresponding to the acquired filename to specify the certificate corresponding to the digital signature A 1241 included in the catalog file A 1240.

If the specified certificate does not exist in the certificate store 1114 of the OS 1110, the OS 1110 displays the security warning screen 1500. The security warning screen 1500 includes information about the issuer of the digital signature A 1241, and asks the user to decide whether to install the driver having the digital signature A 1241 of this issuer. In response to an “INSTALL" button being pressed, the OS 1110 starts the installation of the specified driver. If the “DO NOT INSTALL” button is pressed, the OS 1110 cancels the installation of the driver.

The security warning screen 1500 further includes a checkbox asking the user whether to always trust a driver having a certificate from the same issuer as that of the digital signature A 1241.

When the “INSTALL” button is pressed with this setting enabled, the OS 1110 installs the corresponding certificate in the certificate store 1114. Thus, from the next time onward, when a driver having the same certificate added to the digital signature of the driver is installed, the installation can be performed without displaying the security warning screen 1500. On the other hand, when the “INSTALL” button is pressed with this setting disabled, the OS 1110 displays the security warning screen 1500 again in the installation of a driver having the same digital signature next time.

As described above, display of the security warning screen 1500 to the user by the OS 1110 makes it possible to prevent a driver signed by a suspicious issuer from being installed without the user’s awareness. In the present embodiment, it is on the assumption that the installation is executed with the checkbox asking the user whether to always trust a driver having a certificate from the same issuer checked.

The following is a description of transition of screens displayed on the display unit of the computer 1000 by the installer 1210 when the installer 1210 of the installation set B 1300, which is an upgraded version of the driver, is executed. The basic screen transition is the same as that in FIG. 5, and thus, detailed description thereof will be omitted.

In the conventional technique, the certificate B 1342 added to the digital signature B 1341 of the driver in the installation set B 1300 is different from the certificate A 1242 of the previously installed driver. Thus, the check screen in FIG. 6 is displayed again while the screen 5 (1450) is being displayed.

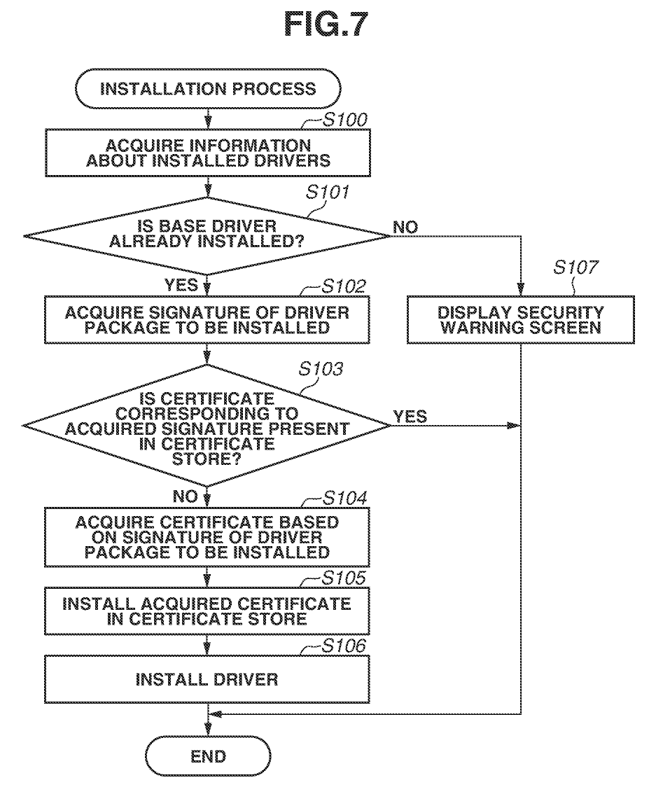

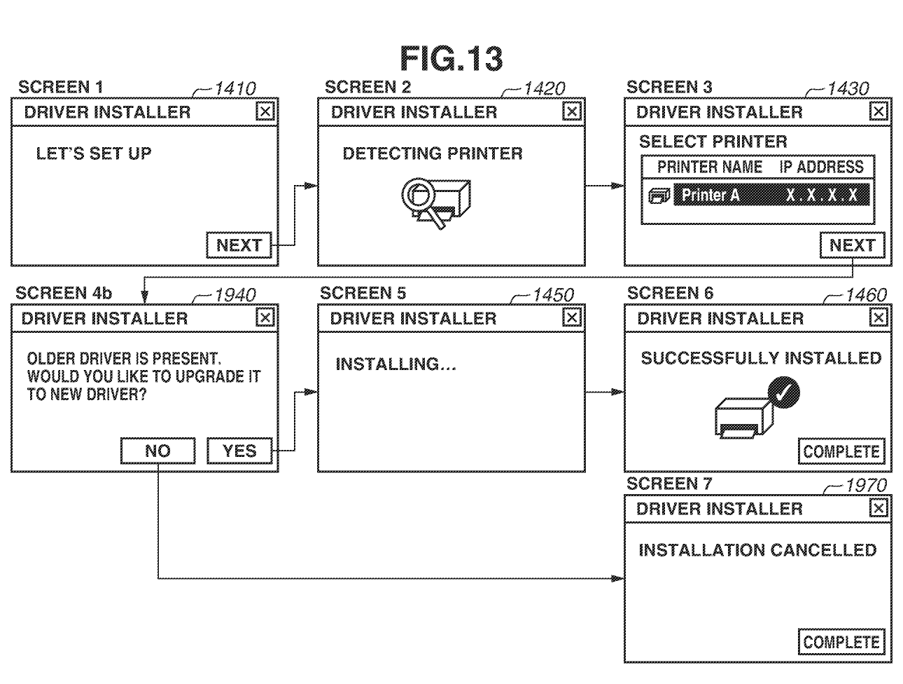

According to the present disclosure, by applying the procedure of a process in FIG. 7, a new version of a driver can be installed without displaying the check screen illustrated in FIG. 6. When an upgraded version of the driver is installed, the screens may transition as illustrated in FIG. 13. In FIG. 13, the same screens as those in FIG. 5 are denoted by the same reference numerals. If the installer 1210 determines that an older driver exists, the installer 1210 may display a screen for asking the user to determine whether to upgrade the driver as illustrated on a screen 4b (1940).

If the user presses a “YES” button on the screen 4b (1940), the installer 1210 displays the screen 5 (1450) and starts to install the driver. If the user presses a “NO” button on the screen 4b (1940), the installer 1210 displays a screen 7 (1970) to notify the user that the installation has been canceled, and the process ends.

The procedure will be described in which the installer 1210 used to carry out the present disclosure installs a driver on the OS 1110 with reference to FIG. 7 with a focus on a feature of the present disclosure. The entire process described here is performed by loading the installer 1210 stored in the storage unit 1030 in the computer 1000 into the memory 1042 and causing the CPU 1041 to execute the installer 1210. The process illustrated in FIG. 7 is executed while the screen 5 (1450) is being displayed by the installer 1210.

First, a procedure of processing will be described in which the installer 1210 of the installation set A 1200 is executed to install the previous version of the driver on the OS 1110 for the first time.

The user activates the installer 1210 to proceed with the operation on the installation screen illustrated in FIG. 5.

In step S100, the installer 1210 acquires information about a list of drivers already installed on the OS 1110 while the screen 5 (1450) is being displayed. Specifically, the installer 1210 uses the OS API to acquire a list of drivers already installed on the OS 1110 and a list of driver versions already installed on the OS 1110.

In step S101, the installer 1210 determines whether an older version of the same type of driver (a base driver) as the driver to be installed is already installed based on the information about the lists acquired in step S100. Step S101 is an example of a determination step and a determination unit.

It is on the assumption that, when the installer 1210 of the installation set A 1200 is executed here, an older version of the same type of driver is not installed on the OS 1110. Thus, the determination in step S101 is “NO”, and the installer 1210 calls the driver installation API of the OS 1110. The process proceeds to step S107.

In step S107, the OS 1110 determines that the certificate A 1242 corresponding to the digital signature A 1241 included in the catalog file A 1240 does not exists in the certificate store 1114 of the OS 1110 to display the security warning screen 1500. In the present embodiment, it is on the assumption that the user presses the “INSTALL” button on the displayed security warning screen 1500 with the checkbox asking the user whether to always trust a driver having a certificate from the same issuer checked.

In step S106, in response to the “INSTALL” button being pressed, the OS 1110 installs the driver file A 1250 of the installation set A 1200. Step S106 is an example of a driver installation step and a driver installation unit.

The above-described user operation causes the OS 1110 to install the certificate A 1242 in the certificate store 1114. As a result, the certificate A 1242 is installed in the certificate store 1114 of the OS 1110.

A procedure of processing will now be described in which the installer 1210 of the installation set B 1300 is executed to install a new version of the driver on the OS 1110 with the driver of the installation set A 1200 already installed. The user activates the installer 1210 of the installation set B 1300. In step S100, while displaying the screen 5 (1450), the installer 1210 acquires the information about the list of the drivers already installed on the OS 1110.

In step S101, the installer 1210 determines whether an older version of the same type of driver as the driver to be installed is already installed based on the information about the list of the drivers already installed on the OS 1110, which is acquired in step S100. In this procedure, at the time of executing the installer 1210 of the installation set B 1300, the driver of the installation set A 1200 is already installed on the OS 1110 as the older version of the same type of driver. Thus, the determination in step S101 is “YES”, and the process proceeds to step S102.

In step S102, the installer 1210 acquires the digital signature B 1341 from the catalog file B 1340 in the driver package B 1320. In step S103, the installer 1210 specifies the certificate B 1342 based on the acquired digital signature B 1341 to check whether the certificate B 1342 exists in the certificate store 1114 of the OS 1110. Specifically, the installer 1210 acquires the serial number of the certificate B 1342 included in the digital signature B 1341 to check whether a certificate having the same serial number exists in the certificate store 1114.

In the present embodiment, a method is described of determining whether the same certificate exists in the certificate store 1114 by using the serial number. However, this determination can be made by using a checksum (a thumbprint) value or a different kind of value.

If no corresponding certificate exists in the certificate store 1114 (NO in step S103), the process proceeds to step S104. In step S104, the installer 1210 acquires the certificate B 1342 based on the digital signature B 1341. In step S105, the installer 1210 installs the certificate B 1342 in the certificate store 1114. The installation of the certificate B 1342 is executed by the installer 1210 calling the certificate installation API provided by the certificate management module 1113 of the OS 1110. Step S105 is an example of a certificate installation step and a certificate installation unit.

In step S106, the installer 1210 calls the driver installation API of the OS 1110 to install the driver file B 1350 of the installation set B 1300 on the OS 1110. In this step, the driver is installed in a state where the certificate B 1342 corresponding to the digital signature B 1341 included in the driver package B 1320 is installed on the OS 1110 in advance in step S105. Thus, the driver can be installed without displaying the security warning screen 1500 by the OS 1110.

In the present embodiment, an example has been described where the certificate B 1342 corresponding to the digital signature B 1341 included in the driver package B 1320, which is the new version, is different from the certificate A 1242 corresponding to the digital signature A 1241 included in the driver package A 1220, which is the previous version.

However, there is a case in which the same certificate is used within the validity period of the certificate A 1242.

In such a case, the installer 1210 determines that the same certificate exists in the certificate store 1114 in step S103, directly executing processing of installing the driver in step S106. In this case, since the same certificate already exists, the driver can be installed without displaying the security warning screen 1500 by the OS 1110.

Further, by installing the driver package B 1320 in step S106, the driver of the driver package A 1220 of the previous version already installed on the OS 1110 is upgraded to the driver of the driver package B 1320 by the processing of the OS 1110.

In the present embodiment, an example has been described in which the installer 1210 executes the process illustrated in FIG. 7 while displaying the installation screen (FIG. 5). However, the installation process illustrated in FIG. 7 may be executed even when the installer 1210 installs the driver (in the background) without displaying the installation screen.

The process performed by the installer 1210 according to the present embodiment has been described. By the installer 1210 operating as described in the present embodiment, even when the new version of the driver is installed for an upgrade, the OS 1110 does not display the security warning screen 1500.

Thus, the user does not hesitate in installation, which can improve the convenience for the user.

### Second Embodiment

In the first embodiment, an example is described where the installer 1210 of a driver determines whether the upgrade installation of the driver is to be performed and whether the certificate is already installed in the certificate store 1114 based on the information from the OS 1110. In the present embodiment, an example will be described where the installer 1210 of a driver determines whether the upgrade installation of the driver to be performed and whether the certificate exists in the certificate store 1114 based on information uniquely managed by the installer 1210 of the driver. The description of the same processing as that in the first embodiment will be omitted, and the difference alone will be described.

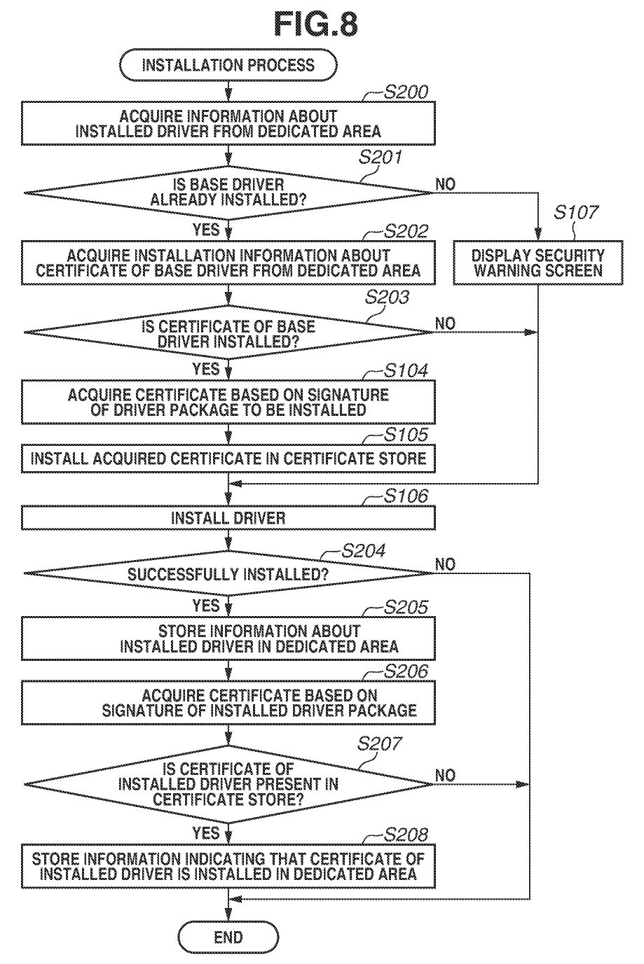

FIG. 8 illustrates a procedure in which the installer 1210 according to the present embodiment installs a driver on the OS 1110 with a focus on a feature of the present disclosure. The entire process to be described here is executed by loading the installer 1210 stored in the storage unit 1030 in the computer 1000 into the memory 1042 and causing the CPU 1041 to execute the installer 1210. The process illustrated in FIG. 8 is executed while the screen 5 (1450) is being displayed by the installer 1210 as in the first embodiment.

A procedure of processing will be described in which the installer 1210 of the installation set A 1200 is executed to install the previous version of driver on the OS 1110 for the first time. The user activates the installer 1210 to proceed with the operation on the installation screen illustrated in FIG. 5. In step S200, while displaying the screen 5 (1450), the installer 1210 acquires information about an installed driver from a dedicated area.

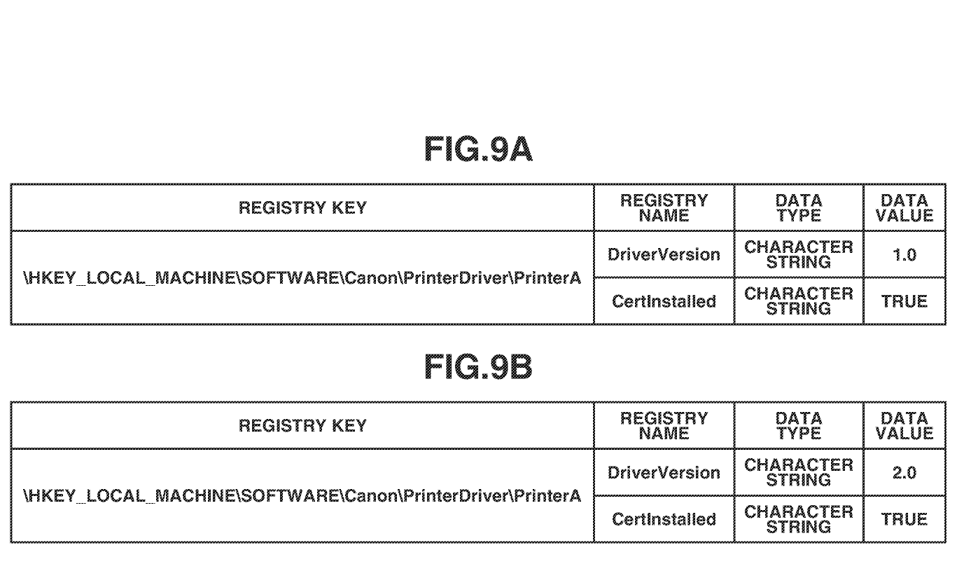

Specifically, the installer 1210 acquires the data value of the registry name “DriverVersion” that is stored in association with the OS registry key uniquely stored as illustrated in FIG. 9A by using the OS API.

In step S201, the installer 1210 determines whether a base driver is already installed based on the driver information (the data value of the registry name “DriverVersion”) acquired in step S200. In this procedure, an older version of the same type of driver is not installed on the OS 1110 at the time of executing the installer 1210 of the installation set A 1200. Thus, the registry information uniquely stored as illustrated in FIG. 9A does not exists. In this case, the determination in step S201 is “NO”, and the installer 1210 calls the driver installation API of the OS 1110. The process proceeds to step S107.

In step S107, the OS 1110 determines that the certificate A 1242 corresponding to the digital signature A 1241 included in the catalog file A 1240 does not exist in the certificate store 1114 of the OS 1110 to display the security warning screen 1500. In the present embodiment, it is on the assumption that the user presses the “INSTALL” button on the displayed security warning screen 1500 with the checkbox asking the user whether to always trust a driver having a certificate from the same issuer checked. In step S106, in response to the “INSTALL” button being pressed, the OS 1110 installs the driver file A 1250 of the installation set A 1200.

The above-described user operation causes the OS 1110 to install the certificate A 1242 in the certificate store 1114, and as a result, the certificate A 1242 is installed in the certificate store 1114 of the OS 1110.

In step S204, the installer 1210 determines whether the installation of the driver is successfully completed. Specifically, unless the driver installation API of the OS 1110, which the installer 1210 has called in step S106, returns an error value, it is determined that the installation is successful. Alternatively, the API of the OS 1110 may make the determination by acquiring a list of drivers already installed on the OS 1110. If the installer 1210 determines that the driver is not successfully installed (NO in step S204), the process ends.

In the present embodiment, it is on the assumption that the driver is successfully installed and the determination in step S204 is “YES”. If the determination in step S204 is “YES”, the process proceeds to step S205. In step S205, the installer 1210 stores the information about the installed driver in the dedicated area.

Specifically, the installer 1210 generates an OS registry key (¥HKEY_LOCAL_MACHINE¥SOFTWARE¥Canon¥PrinterDriver¥PrinterA) illustrated in FIG. 9A by using the OS API. The data value of “1.0”, which is the version number of the driver package A 1220, is stored as the registry name “DriverVersion” by using the OS API.

In this case, when generating a registry key, the installer 1210 acquires the name of the driver to be installed (PrinterA) from the setup information file A 1230 to add the acquired name as the name of the registry key. Definition of the name of the driver as the name of the registry key in this manner allows the name of the driver to be determined to be the information about the same type of driver.

In step S206, the installer 1210 acquires the digital signature A 1241 from the catalog file A 1240 in the driver package A 1220. In step S207, the installer 1210 specifies the certificate A 1242 based on the acquired digital signature A 1241 to check whether the certificate A 1242 exists in the certificate store 1114 of the OS 1110.

Specifically, the installer 1210 acquires the serial number of the certificate A 1242 included in the digital signature A 1241 to check whether a certificate having the same serial number exists in the certificate store 1114. In the present embodiment, a method is described of determining whether a certificate having the same serial number exists in the certificate store 1114 by using the serial number. However, this determination can be made by using a checksum (a thumbprint) value or a different kind of value.

In step S107, If the user presses the “INSTALL” button on the security warning screen 1500 displayed by the OS 1110 with the checkbox unchecked, a certificate having the same serial number does not exist in the certificate store 1114. Thus, the determination in step S207 is “NO”, and the process ends.

In the present embodiment, the user presses the “INSTALL” button on the displayed security warning screen 1500 with the checkbox checked, and the driver of the installation set A 1200 is already installed. Thus, a certificate having the same serial number exists in the certificate store 1114, and the determination in step S207 is “YES”.

In step S207, if the determination is “YES”, the process proceeds to step S208. In step S208, the installer 1210 stores information indicating that the certificate of the installed driver is installed in the dedicated area, and the process ends. Specifically, as illustrated in FIG. 9A, the installer 1210 stores the registry name “CertInstalled” and the date value “TRUE” in association with the OS registry key (¥HKEY_LOCAL_MACHINE (omitted) ¥PrinterA) by using the OS API.

A procedure of processing will be described in which the installer 1210 of the installation set B 1300 is executed to install the upgraded version of the driver on the OS 1110. The user activates the installer 1210 to proceed with the operation on the installation screen illustrated in FIG. 5.

In step S200, the installer 1210 acquires the information about an installed driver from the dedicated area while displaying the screen 5 (1450). Specifically, the installer 1210 acquires the data value of the registry name DriverVersion that is stored in association with the registry key uniquely stored as illustrated in FIG. 9A by using the OS API.

In step S201, the installer 1210 determines whether a base driver is already installed based on the driver information (the data value of the registry name “DriverVersion”) acquired in step S200. In the present embodiment, it is on the assumption that the previous version of the same type of driver is already installed on the OS 1110 at the time of executing of the installer 1210 of the installation set B 1300. Thus, the OS registry information uniquely stored as illustrated in FIG. 9A exists.

The registry value (the data value of the registry name “DriverVersion”) acquired in step S200 is “1.0”, a version older than the version “2.0” of the driver package B 1320 to be installed. Thus, it is determined that the older driver (the base driver) is already installed. As a result, the determination in step S201 is “YES”.

If the determination is “YES” in step S201, the process proceeds to step S202. In step S202, the installer 1210 acquires the installation information about the certificate of the base driver from the dedicated area. Specifically, the data value is acquired of the registry name “CertInstalled” stored in association with the OS registry key (¥HKEY_LOCAL_MACHINE¥ (omitted) ¥PrinterA) illustrated in FIG. 9A by using the OS API.

In step S203, the installer 1210 determines whether the certificate of the base driver is already installed based on the value acquired in step S202. Specifically, if the registry value (the data value of the registry name “CertInstalled”) acquired in step S202 is “TRUE”, it is determined that the certificate of the base driver is already installed. In the present embodiment, since the registry value is “TRUE” as illustrated in FIG. 9A, it is determined that the certificate is already installed. Thus, the determination in step S203 is “YES”.

If the determination is “YES” in step S203, the process proceeds to step S104. In step S104, the installer 1210 acquires the certificate based on the signature of the driver package to be installed. In step S105, the installer 1210 installs the acquired certificate in the certificate store. This process is the same as that in the first embodiment, and thus, detailed description thereof will be omitted.

In step S106, the installer 1210 calls the driver installation API of the OS 1110 to execute the installation process. However, a certificate having the same serial number already exists. Thus, the driver can be installed without displaying the security warning screen 1500 by the OS 1110.

The subsequent operation is the same as that performed when the installation set A 1200 is executed. However, in step S205, the information about the installed driver (the data value of the registry name “DriverVersion”) is upgraded to “2.0” as illustrated in FIG. 9B.

If the registry value (the data value of the registry name “CertInstalled”) cannot be acquired in step S202, it is determined that the certificate of the base driver is not installed in step S203. Thus, the determination in step S203 is “NO”, the processing of steps S104 and S105 are skipped, and the process of installing the certificate added to the signature of the driver package is not performed.

In the present embodiment, an example is described where the OS registry is used for the information uniquely managed by the installer 1210. However, the information may be managed and handled as information in a different format, such as by storing information in a unique file.

The process performed by the installer 1210 according to the present embodiment has been described. By the installer 1210 managing the driver installation status and the certificate installation status as unique information as described in the present embodiment, the OS 1110 does not display the security warning screen 1500. Thus, the user does not hesitate in installation, which improves the convenience for the user.

In addition, in the present embodiment, an example has been described where after a driver is installed, the new driver corresponding to the same printer is installed. However, when a driver corresponding to a different printer is installed, no registry key corresponding to the different printer exists. Thus, the installer does not install the certificate. In the present embodiment, this makes it possible to make a determination limited to the drivers corresponding to the same printer.

### Third Embodiment

In the first and second embodiments, examples have been described where an installation set for drivers includes one driver package alone. In the present embodiment, an example will be described where an installation set for drivers includes a plurality of driver packages. The description of the same processing as that in the first embodiment will be omitted, and the difference alone will be described.

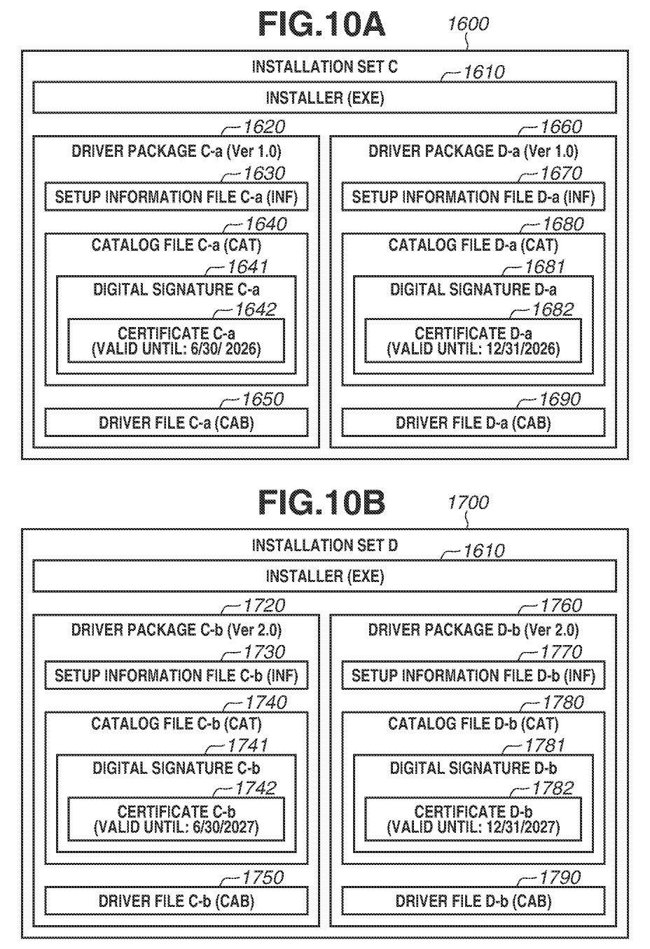

FIG. 10A illustrates a file configuration of an installation set C 1600 of drivers, which are the initial versions of drivers, and FIG. 10B illustrates a file configuration of an installation set D 1700 of drivers, which are the upgraded versions of the drivers, according to the present embodiment.

In the present embodiment, the installation set C 1600 includes one installer 1610 alone as in the first embodiment. However, this installation set C 1600 includes two driver packages 1620 and 1660. For example, in the case of a multifunction printer, these two drivers are a printer driver and a scanner driver. In such a multifunction printer, a plurality of drivers is included in a single device, and the plurality of drivers can be installed by using one installer 1610.

The internal configuration of each of the driver package C-a 1620 and the driver package D-a 1660 is the same as those in the first embodiment.

The driver package C-a 1620 includes a setup information file C-a (INF) 1630, a catalog file C-a (CAT) 1640, and a driver file C-a (CAB) 1650. The catalog file C-a (CAT) 1640 includes a digital signature C-a 1641 of the driver file C-a 1650. A certificate C-a 1642, which is valid until June 30, 2026, is added to the digital signature C-a 1641 as its certificate.

The driver package D-a 1660 includes a setup information file D-a (INF) 1670, a catalog file D-a (CAT) 1680, and a driver file D-a (CAB) 1690. The catalog file D-a (CAT) 1680 includes a digital signature D-a 1681 of the driver file D-a 1690. A certificate D-a 1682, which is valid until December 31, 2026, is added to the digital signature D-a 1681 as its certificate. The certificate C-a 1642 and the certificate D-a 1682 are different certificates.

The installation set D 1700 includes drivers, which correspond to the upgraded versions of the drivers in the installation set C 1600. Specifically, the installation set D 1700 includes a driver package C-b 1720, which corresponds to the upgraded version of the driver package C-a1620, and includes a driver package D-b 1760, which corresponds to the upgraded version of the driver package D-a 1660.

The driver package C-b 1720 includes a setup information file C-b (INF) 1730, a catalog file C-b (CAT) 1740, and a driver file C-b 1750. The catalog file C-b (CAT) 1740 includes a digital signature C-b 1741 of the driver file C-b 1750. A certificate C-b 1742, which is valid until June 30, 2027, is added to the digital signature C-b 1741 as its certificate.

The driver package D-b 1760 includes a setup information file D-b (INF) 1770, a catalog file D-b (CAT) 1780, and a driver file D-b 1790. The catalog file D-b (CAT) 1780 includes a digital signature D-b 1781 of the driver file D-b 1790. A certificate D-b 1782, which is valid until December 31, 2027, is added to the digital signature D-b 1781 as its certificate.

The certificate C-b 1742 and the certificate D-b 1782 are different certificates, and are also different from the certificate C-a 1642 and the certificate D-a 1682, respectively, for the drivers of the previous versions.

A procedure of processing will be described in which the installer 1610 of the installation set C 1600 is executed to install the previous versions of the drivers on the OS 1110 for the first time. The user activates the installer 1610 to proceed with the operation on the installation screen illustrated in FIG. 5.

The installer 1610 executes the process illustrated in FIG. 7 or 8 on each of the driver packages 1620 and 1660 while displaying the screen 5 (1450). Specifically, the installation process of the driver package C-a 1620 is performed in the procedure of the processing in FIG. 7 or FIG. 8. Subsequently, the installation process of the driver package D-a 1660 is executed using the same procedure of processing (FIG. 7 or FIG. 8) as the installation process of the driver package C-a 1620.

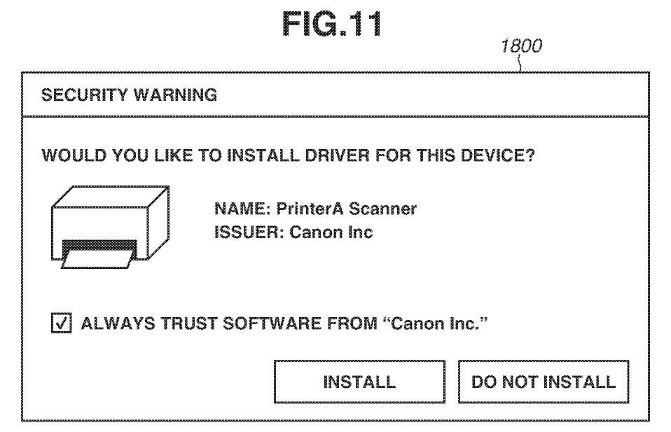

The respective driver packages 1620 and 1660 are handled as different drivers. Thus, in step S101 in FIG. 7 or in step S201 in FIG. 8, it is determined that a base driver for the driver of the driver package D-a 1660, which is executed later, is not installed. Consequently, while the OS 1110 is executing the installation process (S106) of the driver package D-a 1660, the OS 1110 displays a security warning screen 1800 in FIG. 11 because the certificate D-a 1682 does not exist in the certificate store 1114 of the OS 1110.

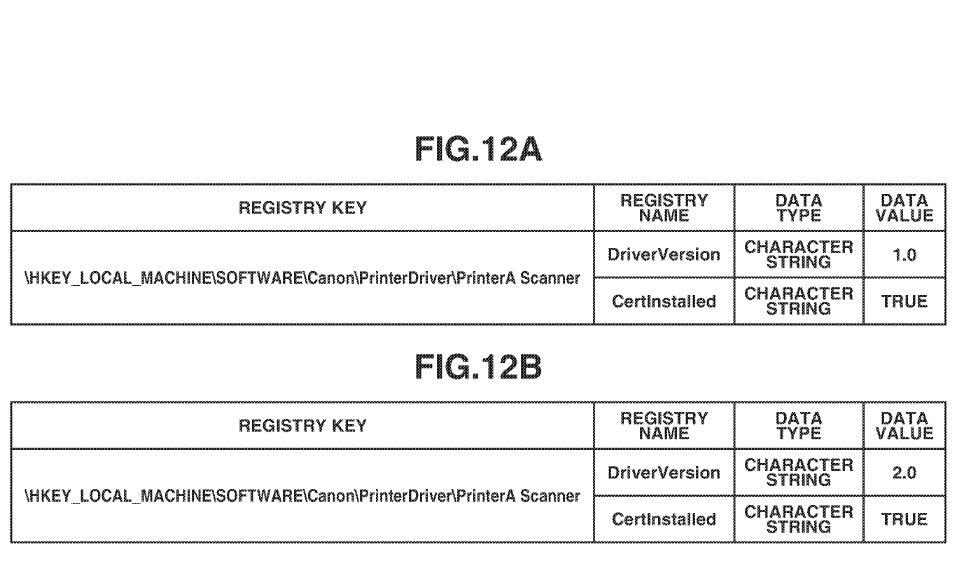

In the present embodiment, it is on the assumption that the user executes the installation on the security warning screen 1800 with the checkbox asking the user whether to always trust a driver having a certificate from the same issuer checked. Thus, in the process in FIG. 8, the driver package C-a 1620 and the driver package D-a 1660 are handled as different drivers. The information about the driver package C-a 1620 corresponds to the data illustrated in FIG. 9A, and the information about the driver package D-a 1660 corresponds to the data illustrated in FIG. 12A.

A procedure of processing will be described in which the installer 1610 of the installation set D 1700 is executed to install the next versions of the drivers on the OS 1110 with the previous versions of the drivers installed on the OS 1110 as described above. The user activates the installer 1610 to proceed with the operation on the installation screen illustrated in FIG. 5.

The installer 1610 performs the process illustrated in FIG. 7 or 8 on each of the driver packages 1720 and 1760 while displaying the screen 5 (1450). Specifically, the installation process of the driver package C-b 1720 is performed in the process procedure in FIG. 7 or FIG. 8. Subsequently, the installation process of the driver package D-b 1760 is performed in the same process procedure (FIG. 7 or FIG. 8) as the installation process of the driver package C-b 1720.

In this case, in step S101 in FIG. 7 or in step S201 in FIG. 8, it is determined that the base drivers for the driver of the driver package C-b 1720 and for the driver of the driver package D-b 1760, which is executed later, are already installed. Thus, in step S105 in FIG. 7 or 8, the installer 1610 installs the certificate C-b 1742 and the certificate D-b 1782 in the certificate store 1114 of the OS 1110.

In the subsequent installation process (S106), when the driver package C-b 1720 and the driver package D-b 1760 are installed, the drivers can be installed without displaying the security warning screen 1500 or the security warning screen 1800. Thereafter, in the process in FIG. 8, the driver package C-b 1720 and the driver package D-b 1760 are handled as different drivers. Thus, the information about the driver package C-b 1720 is represented by the data illustrated in FIG. 9B, and the information about the driver package D-b 1760 is represented by the data illustrated in FIG. 12B.

The process performed by the installer 1610 according to the present embodiment has been described. Even when a plurality of driver packages exists in an installation set as described in the present embodiment, the installer 1610 determines the installation status of each driver and the installation status of each certificate to install a certificate as needed. As a result, the OS 1110 does not display the security warning screen 1500 and the security warning screen 1800. Thus, the user will not hesitate in installation, which can improve the convenience for the user.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-172552, filed October 1, 2024, which is hereby incorporated by reference herein in its entirety.

What is claimed is:

1. A non-transitory computer-readable storage medium storing a program that installs a driver used to control a peripheral device of an information processing apparatus, the stored program, when executed by one or more processors of the information processing apparatus, executes a control method comprising:
determining whether a base driver, which corresponds to an older version of the same type of driver as the driver, is installed on the information processing apparatus;
installing a certificate corresponding to a digital signature included in a driver package of the base driver on the information processing apparatus based on a determination that the base driver is installed; and
installing a driver file included in the driver package of the driver.

2. The non-transitory storage medium according to claim 1, wherein the determination is made by using the version information stored in a dedicated area of the information processing apparatus.

3. The non-transitory storage medium according to claim 1, wherein, the determining further includes determining that the base driver is installed on the information processing apparatus when a name of the driver is included in a name of a registry key in a driver store of the information processing apparatus.

4. The non-transitory storage medium according to claim 1, wherein, in the certificate installing, a certificate is installed in a case where the certificate of the base driver is determined to be installed based on installation information about the certificate stored in a dedicated area for the driver.

5. The non-transitory storage medium according to claim 1, wherein the stored program, when executed by the one or more processors of the information processing apparatus installs a plurality of drivers that controls a plurality of corresponding peripheral devices.

6. A control method for installing a driver used to control a peripheral device of an information processing apparatus, the control method comprising:
determining whether a base driver, which corresponds to an older version of the same type of driver as the driver, is installed on the information processing apparatus;
installing a certificate corresponding to a digital signature included in a driver package of the base driver on the information processing apparatus based on a determination that the base driver is installed; and
installing a driver file included in the driver package of the driver.

7. The control method according to claim 6, wherein version information about the driver installed in the driver installing is stored in a dedicated area.

8. The control method according to claim 7, wherein the determination in the determining is made by using the version information.

9. The control method according to claim 6, wherein, in the determining, it is determined that the base driver is installed on the information processing apparatus in a case where a name of the driver is included in a name of a registry key in a driver store of the information processing apparatus.

10. The control method according to claim 6, wherein, in the certificate installing, a certificate is installed in a case where the certificate of the base driver is determined to be installed based on installation information about the certificate stored in a dedicated area for the driver.

11. The control method according to claim 6, wherein the peripheral device is a printer or a scanner.

12. An information processing apparatus on which a driver used to control a peripheral device is installable, the information processing apparatus comprising:
a memory storing a program; and
one or more processors that, upon execution of the stored program, is configured to operate as:
a determination unit configured to determine whether a base driver, which corresponds to an older version of the same type of driver as the driver, is installed on the information processing apparatus;
a certificate installation unit configured to install a certificate corresponding to a digital signature included in a driver package of the base driver on the information processing apparatus based on a determination that the base driver is installed; and
a driver installation unit for installing a driver file included in the driver package of the driver.
